(19) United States
(12) Patent Application Publication
(10) Pub. No.: US 2008/0162746 A1
(43) Pub. Date: Jul. 3, 2008

(54) Semiconductor apparatus and buffer control circuit

(75) Inventors: Hirokazu Ogura, Yokohama (JP); Kohei Mutaguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/005,617

(22) Filed: Dec. 28, 2007

(30) Foreign Application Priority Data
Dec. 28, 2006 (JP) 2006-354262

(51) Int. Cl. G06F 13/14

(52) U.S. Cl. 710/35

(57) ABSTRACT

A semiconductor apparatus comprises a data processing unit for processing data, a buffer for temporarily storing the data processed by the data processing unit, and a buffer control unit for causing the data stored in the buffer to be burst-transferred to a data storage unit. The buffer control unit allows burst-transfer of the data stored in the buffer to be started before full amount of data to be transferred in a single burst-transfer is stored in the buffer.

### BACKGROUND OF THE INVENTION

1. Field of the Invention

The present invention generally relates to a semiconductor apparatus, and more particularly, to a semiconductor apparatus that temporality stores processed data in a buffer for subsequent burst transfer.

2. Description of the Related Art

A variety of data processing has been achieved by means of various integrated circuits. Video cameras and digital cameras, for example, have integrated circuits for processing in various manner image data captured with an image sensor. Cell phones and portable music players, for example, are equipped with integrated circuits for processing in various manner audio data stored therein. Such integrated circuits for processing a large amount of data, such as image data and audio data, are intensively developed for high throughput.

JP 2006-267661, for example, describes an input signal processing part that makes the phenomenon that image information write to a memory and image information read from the memory pass each other hardly occur. The input signal processing part includes a dual port memory, an effective area determination part, a passing determination part, and a frame memory control part. Input image data is read out synchronously with a signal SCLK asynchronous with an inputted synchronizing signal (ICLK) by the dual port memory. The effective area determination part detects an input period of image data to be displayed on a display part and outputs a detection result as input effective information and input line information. The passing determination part determines whether passing will occur with respect to image data read from an input frame memory or not in accordance with signals ICLK and SCLK, scaling factor information, and input determination threshold information and in consideration of a scaling factor. The frame memory control part controls the input frame memory on the basis of signals SCLK and REQ, input effective information, input line information, and a passing determination result.

In addition, JP 2006-65704, describes an overtaking decision circuit dispensing with a clock swapping circuit even during data transfer between asynchronous clocks, and a data transfer system having the overtaking decision circuit. The overtaking circuit, for deciding that reading by a reading side circuit with respect to data written by a writing side circuit connected to a dual port memory has not overtaken writing by a writing side circuit, is provided with a prediction counter for calculating an address, in the dual port memory, to which the writing side circuit will next write data; a cycle conversion part for predicting time when the writing side circuit will write data into the address calculated by the prediction counter; and a comparison part for deciding that a reading address has not overtaken a writing address by comparing the writing address calculated by the prediction counter with the address read by the reading side circuit.

Moreover, JP 2002-215081 describes a display unit equipped with a frame buffer with a one-frame capacity. An image processing circuit processes data, which is temporarily stored in the frame buffer. The buffered data is output from the frame buffer to a driving circuit of a display panel. The display unit has an internal timing control circuit that can prevent a reading rate to the frame buffer from overtaking a writing rate therein.

Such a control method implemented by the internal timing control circuit allows the reading of data to be started before full data to be outputted in a single burst from the frame buffer, leading to a higher efficiency in data transfer. The control method, however, starts the writing of data to the frame buffer when the burst transfer out of the frame buffer is completed. As a result, the control method is only applicable to such a situation in which the burst output of data from the frame memory starts periodically.

### SUMMARY OF THE INVENTION

According to an aspect of an embodiment, a semiconductor apparatus comprises:

a data processing unit for processing data;

a buffer for temporarily storing the data processed by the data processing unit;

a buffer control unit for causing the data stored in the buffer to be burst-transferred to a data storage unit;

wherein the buffer control unit allows burst-transfer of the data stored in the buffer to be started before full amount of data to be transferred in a single burst-transfer is stored in the buffer.

According to the above aspect of the present invention, it is possible to start burst-transferring of the data stored in the buffer to the data storage unit before full amount of data to be transferred in a single burst-transfer is stored in the buffer, leading to an improved throughput of data transfer.

According to an embodiment, the buffer control unit may allow the burst-transfer of the data stored in the buffer to be started so as to prevent any location in the buffer in which no data to be burst-transferred has been stored from being read.

According to another embodiment, the buffer control unit may allow the burst-transfer of the data stored in the buffer to be started based on a determination that amount of data stored in the buffer reaches a predetermined amount value.

In the above embodiment, the predetermined amount value may be determined to satisfy

N>(1−r0/r0)*M,

where M being the full amount of data to be transferred in a single burst-transfer, r0 being a rate at which data processed by the data processing unit is written to the buffer, r1 being a rate at which data stored in the buffer is burst-transferred to the data storage unit.

According to another aspect of the present invention, a buffer control circuit for controlling a buffer that temporarily stores data processed by a data processing unit comprises:

a counter for counting amount of data stored in the buffer;

a register for storing a predetermined amount value determined such that the buffer control circuit allows burst-transfer of data stored in the buffer to be started before full amount of data to be transferred in a single burst-transfer is stored in the buffer so as to prevent any location in the buffer in which no data to be burst-transferred has been stored from being read; and

a determination circuit for determining that the amount of data counted by the counter matches the predetermined amount value stored in the register.

According to yet another aspect of the present invention, a method of controlling burst-transfer comprises:

storing in a buffer, data to be burst-transferred;

allowing the buffer to start burst-transfer of the data stored therein before full amount of data to be transferred in a single burst-transfer is stored in the buffer, so as to prevent any location in the buffer in which no data to be burst-transferred has been stored from being read.

Other objects, features, and advantages of the present invention will be more apparent from the following detailed description when read in conjunction with the accompanying drawings.

### BRIEF DESCRIPTION OF THE DRAWINGS

FIG. 1 is a block diagram showing a conventional image processing macro;

FIG. 2(a)-2(h) show waveforms of buffer RAM control signals of a conventional image processing macro shown in FIG. 1;

FIG. 3 is a block diagram showing an image processing semiconductor apparatus according to an embodiment of the present invention;

FIG. 4 is a block diagram showing an image processing macro according to an embodiment;

FIG. 5(a)-5(h) show waveforms of buffer RAM control signals of the image processing macro shown in FIG. 4;

FIG. 6(a)-6(h) show waveforms in a circled portion of FIG. 5 in a magnified form;

FIG. 7 is a schematic diagram for explaining the derivation of conditional formula for sending output request permission signal based on the amount of image data stored in the buffer;

FIG. 8 is a block diagram showing a circuit for generating output request permission signal of an image processing macro according to an embodiment;

FIG. 9 is a block diagram showing a variation of an image forming apparatus according to another embodiment;

FIG. 10(a)-10(g) show waveforms of buffer RAM control signals of the variation of the image processing macro shown in FIG. 9;

FIG. 11 is a block diagram showing yet an other variation of an image processing macro according to yet an other embodiment; and

FIG. 12(a)-12(h) show waveforms of buffer RAM control signals of the yet other variation of an image processing macro shown in FIG. 12.

### DETAILED DESCRIPTION OF THE PREFERRED EMBODIMENTS

The preferred embodiments of the present invention are described below with reference to the drawings.

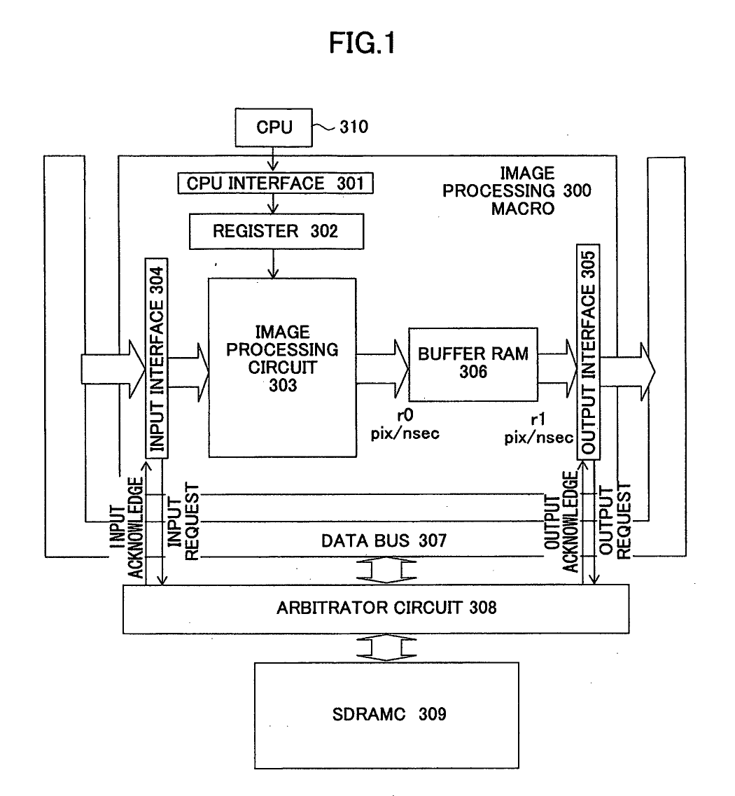

FIG. 1 is a block diagram showing an image processing macro for processing images. The image processing macro may be a part of a semiconductor integrated circuit (IC or LSI, for example) for processing image data. The semiconductor integrated circuit may be built in image capturing devices such as digital cameras and cell phones with image capturing function.

As shown in the figure, the image processing macro 300 may include a CPU (central processing unit) interface 301, a register 302, an image processing circuit 303, an input interface 304, an output interface 305, and a buffer RAM (random access memory) 306. The CPU interface 301 is an interface circuit for interfacing the image processing macro 300 with a CPU (central processing unit) for controlling the image processing macro 300. The CPU is provided outside of the image processing macro 300 and connected thereto (more particularly, to the CPU interface 301). The register 302 is a register in which various parameters and other information provided by the CPU 310 are stored. The input interface 304 interfaces the other part of the image processing macro 300 with a data bus 307. Image data to be processed by the image processing macro 300 is input to the image processing macro 300 via the input interface 304. The output interface 305 is an interface circuit for outputting image data processed by the image processing macro 300 to the data bus 307.

The image processing circuit 303 receives image data from the data bus 307 via the input interface 304, and processes in accordance with instructions given by the CPU 310. The resulting image data which has been processed by the image processing circuit 303 is sent to the buffer RAM 306 for temporary storage. The buffer RAM 306 temporarily stores the image data processed by the image processing circuit 303, and then outputs the image data to the data bus 307 via the output interface 305.

There provided an arbitration circuit 308 which arbitrates the accesses to the data bus 307 performed by the image processing macro 300 and other image processing macros (not shown) to prevent multiple image processing macros from using the data bus 307 simultaneously. The arbitration circuit 308 exchanges input request signals and input acknowledge signals with the input interface 304 of the image processing macro 300, and exchanges output request signals and output acknowledge signals with the output interface 305 of the image processing macro 300. When the image processing circuit 303 is ready for processing image data, the input interface 304 sends an input request signal to the arbitration circuit 308. The arbitration circuit 308 causes, in response to the input request signal, another component such as a SDRAM card 309 to output image data to be processed by the image processing circuit 303, to the data bus 307, and then sends an input acknowledge signal to the input interface 304. The input interface 304 receives the image data output by the SDRAM card 309, for example, from the data bus 307 in response to the input acknowledge signal. Similarly, when the buffer RAM 306 is ready for outputting image data buffered therein, the output interface 305 sends an output request signal to the arbitration circuit 308. The arbitration circuit 308 causes, in response to the output request signal, another component such as the SDRAM card 309 to prepare for receiving image data which was processed by the image processing circuit 303 and has been buffered by the buffer RAM 306, and then sends an output acknowledge signal to the output interface 305. The output interface 305 causes the image data temporarily stored (buffered) in the buffer RAM 306 to be output to the data bus 307 in response to the output acknowledge signal from the arbitration circuit 308.

If the image processing macro 300 processes image data by a given unit such as a frame or a line, a memory unit with capacity of the given unit is often used as the buffer RAM 306. In the following description, an assumption is made that the image data is processed line by line, which means that one line of the image data is processed and buffered at a time.

The data transfer rate at which image data processed by the image processing circuit 303 is written to the buffer RAM 306 and the data transfer rate at which image data buffered by the buffer RAM 306 is read out to the data bus 307 via the output interface 305 are determined by multiplying bus width and bus clock cycle. The bus clock cycle on the input side of the buffer is the operating clock cycle of the image processing circuit 303, whereas the bus clock cycle on the output side of the buffer is the bus clock cycle of image data transfer part (including the arbitration circuit 308 and a destination of the image data (in this case, the SDRAM card 309). The input side and output side of the buffer usually operate asynchronously. In such a case, a dual port RAM may be conveniently used as the buffer RAM 306.

The size (amount) of data which is transferred in a continuous manner in response to a single data transfer request (output request signal) is assumed to be one line of image data. In the following description, a “burst transfer” is defined as a transfer of data in a continuous manner in response to a single data transfer request, and the size of data to be transferred in a burst transfer is called “one burst.”

When image data of one burst or more is stored in the buffer RAM 306, the image processing macro 300 then sends a data transfer request to output the image data.

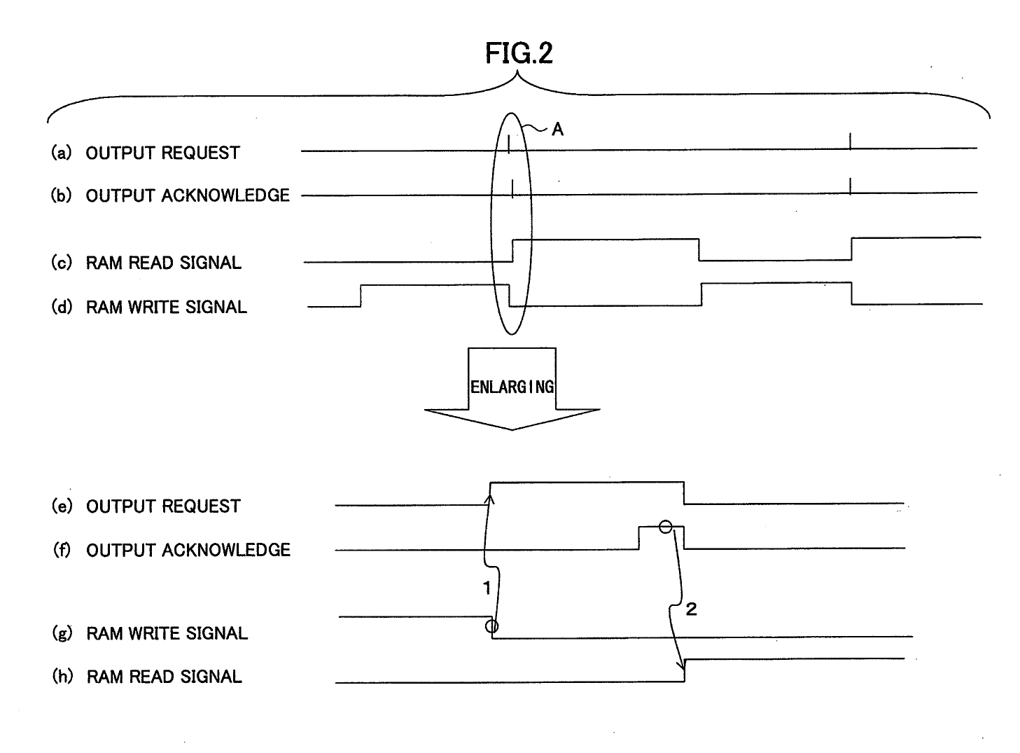

FIG. 2(a)-2(h) show waveforms of the control signals of the buffer RAM 306 provided in the image processing macro 300 shown in FIG. 1. FIG. 2(e)-2(h) shows the portion A (indicated by an oval) of FIG. 2(a)-2(d), respectively, in an expanded form in the direction of time. In FIG. 2(a)-2(h) and the other figures showing waveforms, the name of the signal whose waveform is shown in the figure is indicated at the left side of the waveform.

When one line of image data is written to the buffer RAM 306, and write signal (shown in FIGS. 2(d) and 2(g)) is negated (in this case, turned to low level), output request (shown in FIGS. 2(a) and 2(e)) is asserted (in this case, turned to high level), which causes the image data stored in the buffer RAM 306 to be output to the image data transfer part. When the output request is accepted by the image data transfer part, and output acknowledge (shown in FIGS. 2(b) and 2(f)) is received, read signal of the buffer RAM 306 is asserted to start the reading of the image data.

The image processing macro 300 shown in FIG. 1 starts the transfer of image data from the buffer RAM 306 when the output interface 305 sends the output request to the arbitration circuit 308 and then receives the output acknowledge, the transfer of image data from the buffer RAM 306 is not necessarily occur periodically, and as a result the method described in JP 2002-215081 is not applicable.

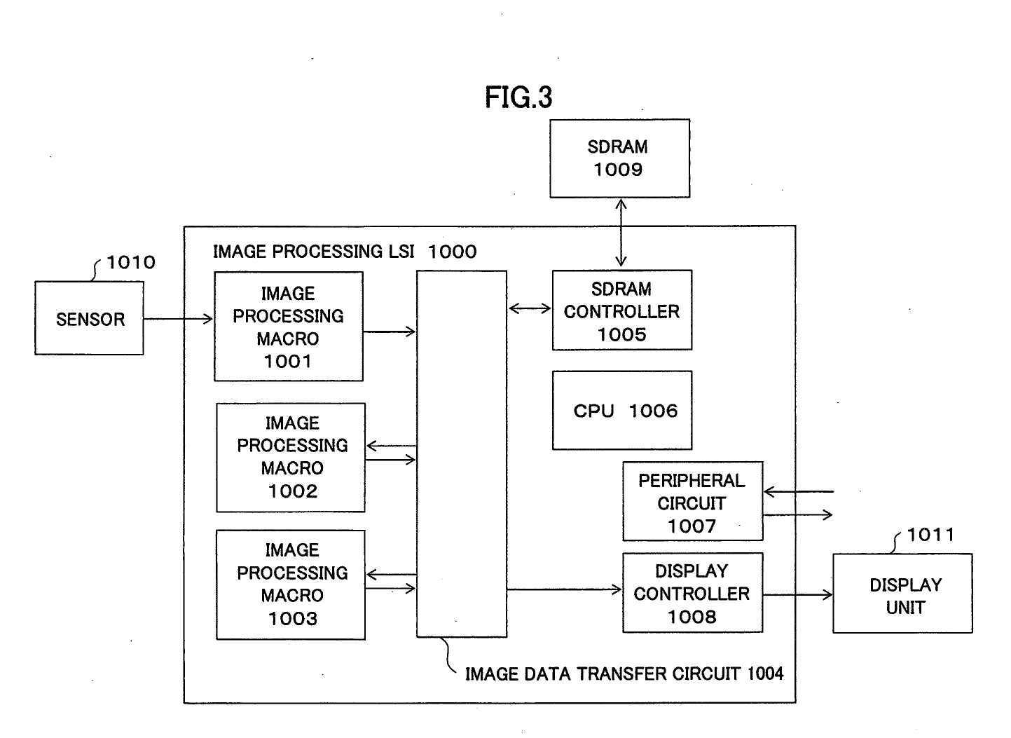

FIG. 3 is a block diagram showing a semiconductor apparatus according to an embodiment of the present invention, and more particularly, FIG. 3 shows an image processing semiconductor integrated circuit (image processing LSI) 1000 according to an embodiment. The image processing LSI 1000 is built in an image capture device such as a digital camera and a cell phone with image capture function for performing a variety of image processing. It should be appreciated, however, that the present invention is applicable to any suitable type of semiconductor apparatus that processes any suitable type of data such as audio data, computer data, and moving picture data.

The image processing LSI 1000 includes multiple image processing macros 1001-1003, an image data transfer circuit 1004, a SDRAM controller 1005, a CPU 1006, a peripheral circuit 1007, and a display controller 1008. The multiple image processing macro 1001-1003 processes in a various way image data captured by an image sensor 1010 provided outside of the image processing LSI 1000. The image data transfer circuit 1004 transfers image data between the image processing macros 1001-1003 and the SDRAM 1009 via a SDRAM controller 1005 that controls the SDRAM 1009. The CPU 1006 controls the overall operation of the image processing LSI 1000. The peripheral circuit 1007 includes various functional circuits such as a timer and a card controller. The display controller 1008 controls a display device such as LCD and EL display that are provided outside of the image processing LSI 1000.

The image data captured by the sensor 1010 is sent to the (first) image processing macro (circuit) 1001 for processing, and then stored in the SDRAM 1009. The image data processed by the first image processing macro 1001 and stored in the SDRAM 1009 may be read out to the (second) image processing macro (circuit) 1002 for another type of processing, and then stored in the SDRAM 1009 again. The image data processed by the second image processing macro 1002 and stored in the SDRAM 1009 may be read out to the (third) image processing macro (circuit) 1003 for yet another type of processing, and then stored in the SDRAM 1009 again.

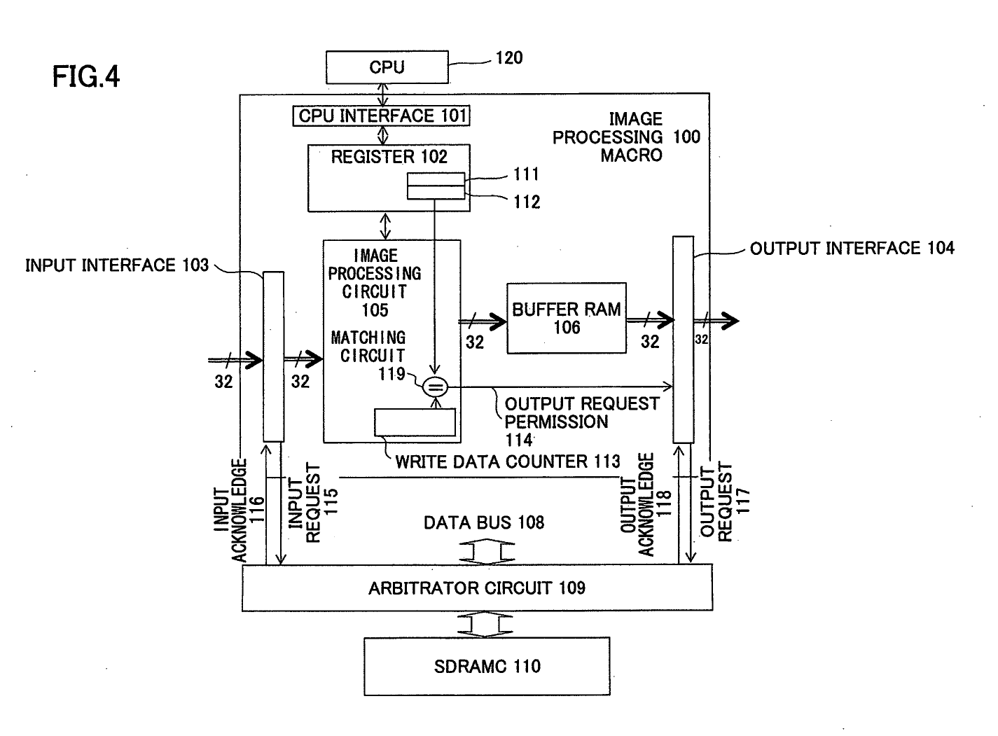

FIG. 4 is a block diagram showing an image processing macro according to an embodiment of the present invention. The image processing macro may be included in the image processing LSI 1000 shown in FIG. 3. The image processing macro 100 shown in FIG. 4 may be one of the image processing macro 1001-1003 shown in FIG. 3. The image processing macro 100 may include a CPU interface 101, a register 102, an input interface 103, an output interface 104, an image processing circuit 105, and a buffer RAM 106. The image processing macro 100 may include an interface circuit for receiving image data from the sensor 1010 shown in FIG. 3.

The CPU interface 101 is an interface circuit that interfaces the image processing macro with a CPU 120. The register 102 is a register for storing various types of parameters related to image processing received from the CPU 120 via the CPU interface 101. The input interface 103 and the output interface are interface circuits that enable the image processing macro 100 to input or output, respectively, image data with the image data transfer unit via a data bus 108. The buffer RAM 106 is a random access memory (RAM) for buffering image data processed by the image processing circuit 105. The buffer RAM 106 may have a capacity that is equal to or more than one line of image data (frame), and may be 32 bit-wide, 1R1W-type, 2-port RAM with one read port and one write port, for example. The image processing circuit 105 may be a circuit for processing the image data. Processing of the image processing circuit 105 may include, but not limited to, one of contrast conversion, filtering, edge enhancement, and any suitable combination thereof.

In operation, when the image processing circuit 105 has completed processing of one line of image data and is ready for processing next one line of image data, the input interface 103 sends an input request 115 to an image data transfer unit. When the input interface 103 receives an input acknowledge 116 from the image data transfer unit, the input interface 103 causes the image data to be inputted. The image data transfer unit is, for example, the image data transfer circuit 1004 described above with reference to FIG. 3, and may include the data bus 108 and the arbitration circuit 109.

The register 102 may store parameters such as (i) parameters used for image processing such as threshold value and weights, (ii) bits 111 for enabling/disabling a function to cause output request to be sent before full amount of one line of image data is stored in the buffer RAM 106, and (iii) bits 112 indicating a predetermined amount of image data based on which the output request is sent when the amount of image data stored in the buffer RAM 106 exceeds the predetermined amount.

On the other hand, the image processing circuit 105 is provided with a write data counter 113 for counting the amount of data written in the buffer RAM 106, and a matching circuit 119. If the bits 111 indicates that the function is enabled which causes the output request to be sent before one line of image data is fully buffered in the buffer RAM (that is, in the middle of the data transfer of unit amount of image data corresponding to one line), the matching circuit 119 determines whether the count of the write data counter 113 matches the bits 112 stored in the register 102 (the bit 112 indicating a predetermined amount of image data based on which the output request is sent when the amount of image data stored in the buffer RAM 106 exceeds the predetermined amount). If the matching circuit 119 determines that the count of the write data counter 113 matches the bits 112 stored in the register 102, the matching circuit 119 sends an output request permission signal 114 to the output interface 104.

In response to reception of the output request permission signal 114 from the matching circuit 119, the output interface 104 sends an output request 117 to the image data transfer unit (including data bus 108 and an arbitration circuit 109). Then, in response to reception of output acknowledge 118 from the image data transfer unit, the output interface 104 asserts read signal to the buffer RAM 106 to start data transfer from the buffer RAM 106. In the data transfer, one line of image data is burst transferred in a continuous manner.

When one line of image data (image data size of which corresponds to one line) is transferred out of the buffer RAM, the input interface 103 sends an input request 115 to the image data transfer unit to cause the next one line of image data to be input to the image processing circuit 105. In response to reception of input acknowledge signal 116 from the image data transfer unit, the image processing circuit 105 reads image data via the input interface 103.

Although an exemplary image processing macro are described with respect to FIG. 4, it should be appreciated that the present invention can be applied to any suitable circuit for processing any suitable data, including audio data and other computer data.

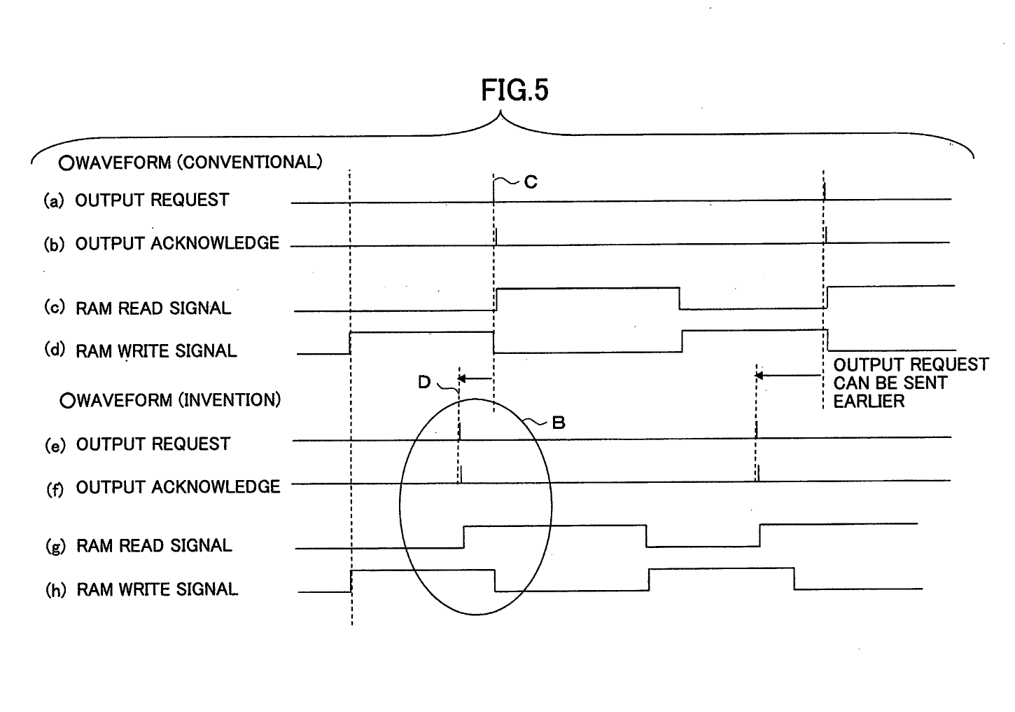

Additionally referring to FIG. 5, the control operation of buffer RAM according to an embodiment is described in detail. FIG. 5 is a waveform diagram showing waveforms related to the data transfer of the image processing macro 100 according to an embodiment of the present invention. FIG. 5(a)-5(d) are the waveforms of conventional image processing macro shown in FIG. 2(a)-2(d), respectively, for comparison. FIG. 5(e)-5(h) show the waveform of the buffer RAM control signals of the image processing macro according to an embodiment.

While the write signal (shown in FIG. 5(h)) is asserted (in this case, turned to high level), image data processed by the image processing circuit 105 are being written to the buffer RAM 106. The write data counter 113 (FIG. 4) counts the amount of image data (in this case, the number of pixels) processed by the image processing circuit 105 and written to the buffer RAM 106. In the following description of this embodiment, an assumption is made that, during one clock cycle, one pixel is written from the image processing circuit 105 to the buffer RAM 106.

It is assumed that the bits 111 of the register 102 (FIG. 4) indicates the function is enabled that causes an output request to be sent (more particularly, an output request permission 114 being sent to the output interface 104) before full one line of image data is stored in the buffer RAM 106 (in the middle to the one line of image data being stored in the buffer RAM 106). A further assumption is made that the value of the bits 112 of the register 102 is set to an integer “N” (N is equal to or more than 1, and equal to or less than “M,” where M being the number of pixels in one line). The value “N” of the bits 112 of the register 102 indicates the amount of image data to be stored in the buffer RAM 106 before the output request is sent (more accurately, the output request permission 114 is sent to the output interface 104).

When the counts of the write data counter 113 reaches the value “N”, the matching circuit 119 sends the output request permission signal 114. In response to reception of the output request permission signal 114, the output interface 104 sends the output request signal 117 (FIG. 5(e)) to the arbitration circuit 109.

Thus, the image processing macro according to an embodiment causes the buffer RAM to start the burst transfer at a time D (shown by dotted line D) which is earlier than a time C (shown by dotted line C) at which the conventional image processing macro does.

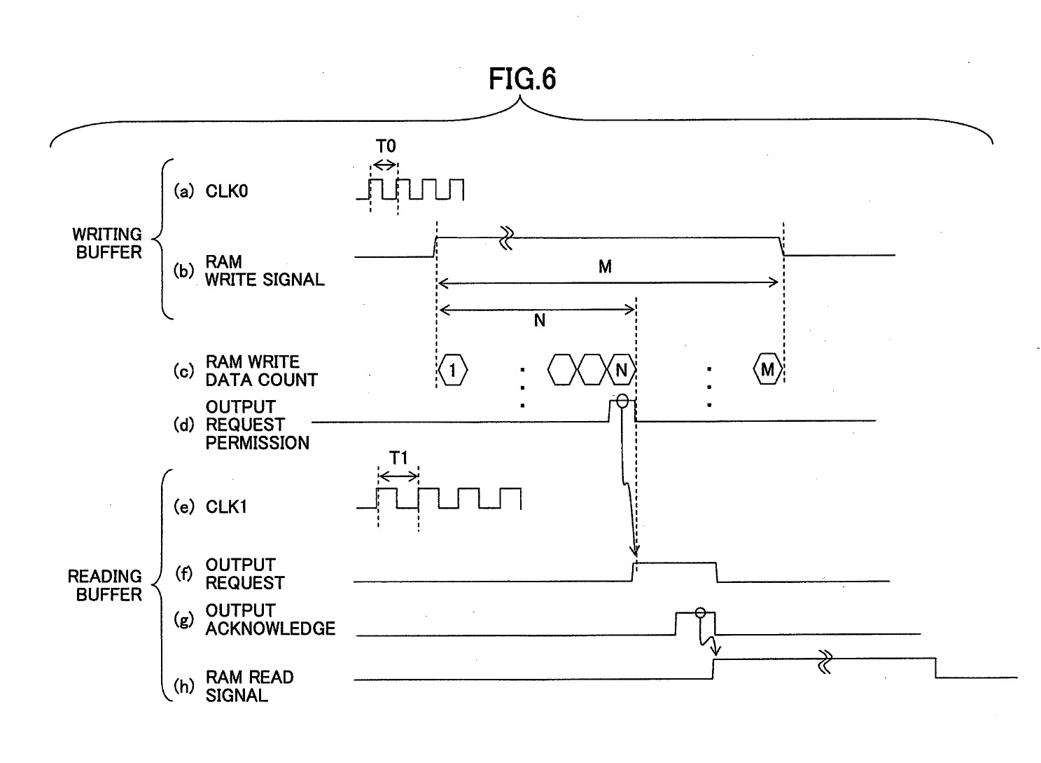

FIG. 6 shows in an enlarged manner the portion of waveforms related to the data transfer of the image processing macro 100 according to an embodiment, the portion being indicated by oval B in FIG. 5.

In this embodiment, it is assumed that each line of the image data includes “M” pixels. A further assumption is made that, at input (write) side of the buffer RAM 106, the cycle of clock CLK0 (shown in FIG. 6(a)) is T0 (nsec), and at output (read) side of the buffer RAM 106, the cycle of clock CLK1 (shown in FIG. 6(e)) is T1 (sec).

While the write signal (shown in FIG. 6(b)) is asserted (in this case, turned to high level), image data processed by the image processing circuit 105 are being written to the buffer RAM 106 at a rate of one pixel per one cycle of the clock CLK0 (FIG. 6(a)). The write data counter 113 counts the amount of image data (in this case, the number of pixels) processed by the image processing circuit 105 and written to the buffer RAM 106 as shown in FIG. 6(c).

When the count of the write data counter 113 reaches the value “N,” the match circuit 119 asserts (in this case, turns to high level) the output request permission signal 114 as shown in FIG. 6(d). The output request permission signal (shown in FIG. 6(d)) is generated in synchronization with the clock CLK0. In response to reception of the output request permission signal, the output interface 104 generates the output request signal (shown in FIG. 6(f)) in synchronization with the clock CLK1 (shown in FIG. 6(e)). Then, in response to reception of the output acknowledge signal (shown in FIG. 6(g)) from the image data transfer unit, the output interface asserts the read signal (shown in FIG. 6(h)). In response to the asserting of the read signal (FIG. 6(h)), the output data transfer (burst transfer) from the buffer RAM 106 is started.

It is noted that the value “N” can be determined as follows:

N>(1−r0/r1)*M (1)

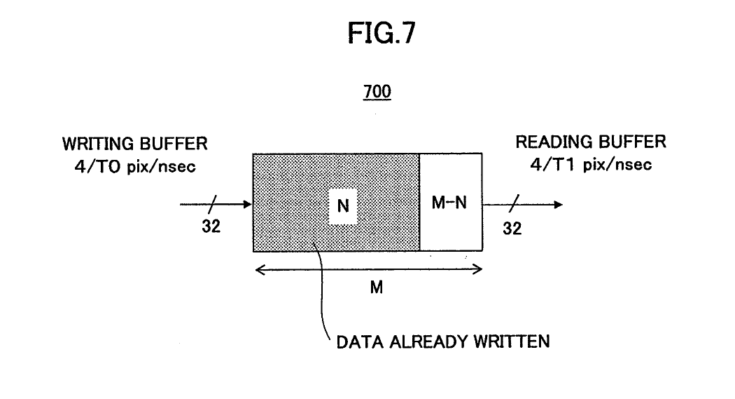

FIG. 7 is a schematic diagram for explaining the derivation of the expression (1).

FIG. 7 shows a buffer 700 to which image data is being written at its write side with clock CLK0 (cycle T0), and from which the written image data is being read at its write side with clock CLK1 (cycle T1). An assumption is made that N pixels have been written to the buffer RAM 700. Another assumption is made that one pixel is composed of 8 bits, and 32 bits of image data are written to the buffer RAM in each clock cycle. Under such assumptions, a time period required for writing the remaining (M−N) pixels in the M pixels of one line can be expressed as follows:

(M−N)/4*T0(nsec) (2)

Further assumption is made that 32 bits of image data are read from the buffer RAM in each clock cycle. Under such an assumption, a time period required for reading both the N pixels that have been already written and the M−N pixels that are to be written (that is, M pixels in total) can be expressed as follows:

M/4*T1(nsec) (3)

To prevent locations in the buffer where no data has been written from being read, it is necessary to complete the writing of one line of image data to the buffer before one line of image data written to the buffer is read. Accordingly, the time period shown in the expression (2) needs to be shorter than the time period shown in the expression (3). This results in:

(M−N)/4*T0<M/4*T1 (4)

The expression (1) can be derived from the expression (4) using the relation between cycle and transfer rate: T0=1/r0 and T1=1/r1.

It is noted that, according to an embodiment, in the image processing macro 100 shown in FIG. 4, there may be provided a deriving unit (not shown) that derives the value “N” that satisfies the above expression (1) based on the data transfer rate r0 at the input side of the buffer and the data transfer rate r1 at the output side of the buffer derived from the operation frequency of the image processing circuit and the bus clock frequency of the image data transfer unit, respectively. In such an embodiment, the deriving unit can automatically update the value “N” in the bits 112. Alternatively, the deriving unit may provide the value “N” directly to the matching circuit 119 without storing the value “N” in the register 102. In such a case, it may not be necessary to provide the bits 112 in the register 102 that indicates the amount of image data to be stored in the buffer RAM 106 before the output request is sent.

In addition, even if the clock frequency of the image processing circuit and/or the clock frequency of the data transfer unit are changed in order to lower power consumption, for example, the deriving unit can derive the value “N” each time those frequencies are changed to shift timing at which the transfer request is sent.

If the SDRAM 1009 in FIG. 3 is replaced with a SDRAM with different frequency, or if the bus clock of the image data transfer circuit 1004 is changed, the deriving unit can re-derive (re-calculate) the value “N” to shift timing at which the transfer request is sent, which increases the flexibility of the system.

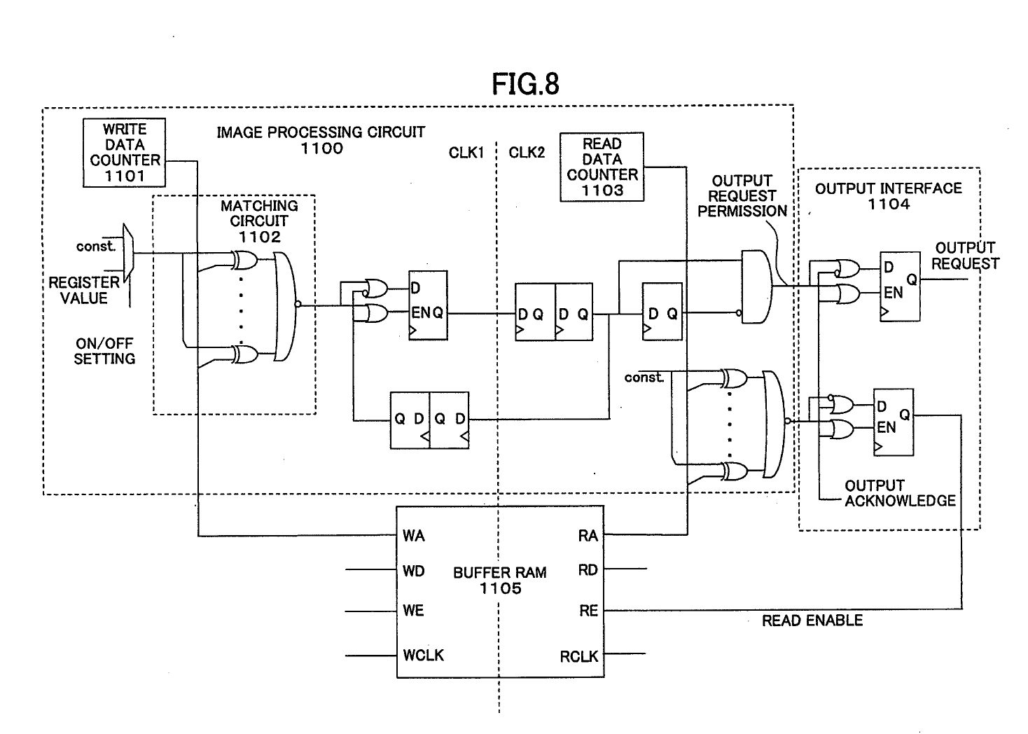

FIG. 8 is a block diagram showing a circuit for generating the output request permission signal according to an embodiment of the present invention. FIG. 8 shows an image processing circuit 1100 (corresponding to the image processing circuit 105 of FIG. 4), a buffer RAM 1105 (corresponding to the buffer RAM 106 of FIG. 4), and an output interface circuit 1104 (corresponding to the output interface 104 of FIG. 4).

The image processing circuit 1100 includes a matching circuit 1102 (corresponding to the matching circuit 119 of FIG. 4). The matching circuit 1102 compares the amount of image data written to the buffer RAM 1105, which amount (count) is indicated in the write data counter 1101 (corresponding to the write data counter 113 of FIG. 4), with a register value (set in the bits 112 of the register 102 shown in FIG. 4), and if a match is found, the matching circuit 1102 sends a one-shot pulse in synchronization with clock CLK1. The signal (pulse) output by the matching circuit 1102 is converted into an output request permission signal, which is in synchronization with clock CLK2.

When the output request signal is asserted, an output request of the output interface 1104 is set. The output request is reset when an output acknowledge indicating the acceptance of the output request by an arbitration circuit (not shown) is asserted.

In response to the output acknowledge being asserted, the output interface 1104 sets a read enable signal connected to the buffer RAM 1105 to start data transfer (burst transfer) from the buffer RAM 1105. A read data counter 1103 counts the amount of image data, and resets a read enable signal when the count reaches the full amount of image data to be burst transferred. In the above description, the clock CLK1 is the clock frequency of the image processing circuit 1100 and the clock CLK2 is the bus clock frequency of the image data transfer unit.

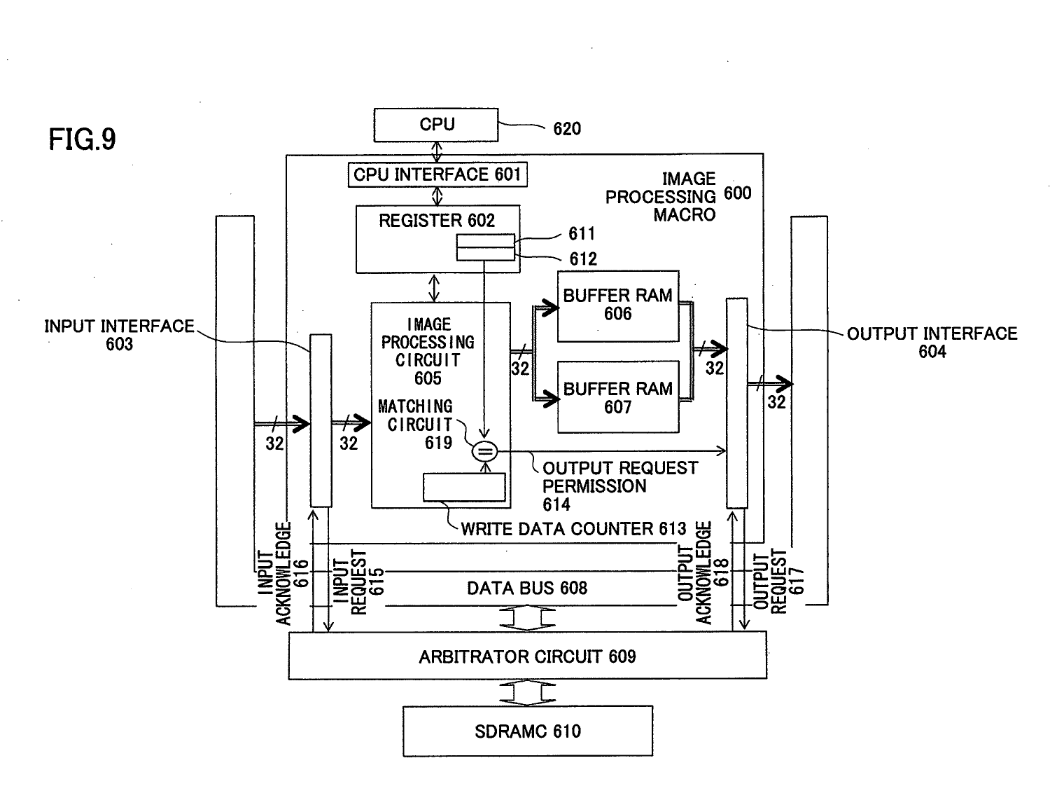

FIG. 9 is a block diagram showing an image processing macro according to another embodiment of the present invention. The image processing macro 600 shown in FIG. 9 is different from the image processing macro 100 shown in FIG. 4 in that the buffer RAM includes two sub-buffers. That is, the image processing macro 600 according to the present embodiment uses two buffer RAMs 606 and 607, each having capacity of one line of image data, as sub-buffers. According to the above arrangement, image data can be stored (written) in one of the buffer RAMs (the buffer RAM 606, for example), while image data stored in the other of the buffer RAMs (the buffer RAM 607, for example) is being burst transferred (read), leading to an increased efficiency. The buffer RAMs 606 and 607 are, for example, 32-bit RAMs with both one read port and one write port (1R1W). Remaining configuration of the image processing macro 600 is basically the same as the image processing macro 100 described with reference to FIG. 4.

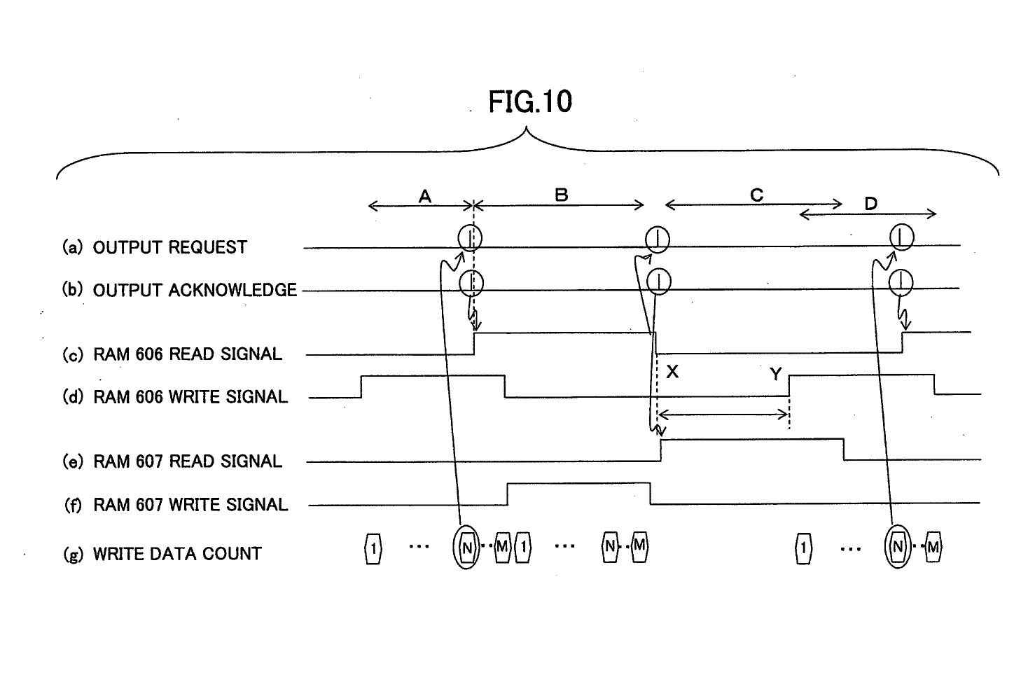

FIG. 10 is a waveform diagram showing the control signal waveforms of the buffer RAMs 606 and 607 according to the above embodiment.

An assumption is made that the function is enabled to cause the output request to be sent before one line of image data is stored in the buffer RAMs 606 and 607, which is indicated in the bits 611 in the register 602. Another assumption is also made that an integer “N” (equal to or more than zero, and equal to or less than “M”) is indicated in the bits 612 of the register 602, which integer N indicates how much image data needs to be stored in the buffer RAM 606 and 607, before the output request is allowed to be sent.

In FIG. 10, it is shown that the read signals of both buffer RAMs 606 and 607 are not asserted in the first time period A, which means no image data is burst transferred (read) from the buffer RAMs 606 and 607. In this time period A, the write data count (shown in FIG. 10(g)) indicates the amount of image data stored in the buffer RAM 607, and the output request (shown in FIG. 10(a)) is asserted when the write data count reaches “N.” In response to the output acknowledge signal (shown in FIG. 10(b)), the read signal of the buffer RAM 606 (shown in FIG. 10(c)) is asserted, which causes the burst transfer from the buffer RAM 606 to be started.

In time period B, the read signal of the buffer RAM 606 (shown in FIG. 10(c)) is asserted, which means the image data stored in the buffer RAM 606 is being burst transferred. Even when the write data count (shown in FIG. 10(g)) reaches N, the output request (shown in FIG. 10(a)) for burst transferring image data stored in the buffer RAM 607 is not asserted. However, the output request (shown in FIG. 10(a)) for burst transferring image data stored in the buffer RAM 607 is asserted when the burst transfer of image data stored in the buffer RAM 606 is completed. Then, the image data stored in the buffer RAM 607 starts to be burst transferred (read).

During a time period between time X at which burst transfer from the buffer RAM 606 is completed and time Y at which image data starts to be written to the buffer RAM 606, the image processing circuit 605 processes the line of image data next to that being read from the buffer RAM 607 in the time period C.

In the time period C, at the time Y when the next line of image data is ready for storage in the RAM 606, the write signal for the buffer RAM 606 (shown in FIG. 10(d)) is asserted for storage from the image processing circuit 605 to the buffer RAM 606.

In the time period D, the write signal (shown in FIG. 10(d)) for the buffer RAM 606 is asserted for storage from the image processing circuit 605 to the buffer RAM 606. When the write data count (shown in FIG. 10(g)), which indicates the amount of image data stored in the buffer RAM 606, reaches N, the write signal for the buffer RAM 607 has been negated (turned to low level), which means no data is being read from the buffer RAM 607. The output request (shown in FIG. 10(a)) is asserted for reading image data stored in the buffer RAM 606 to start the reading.

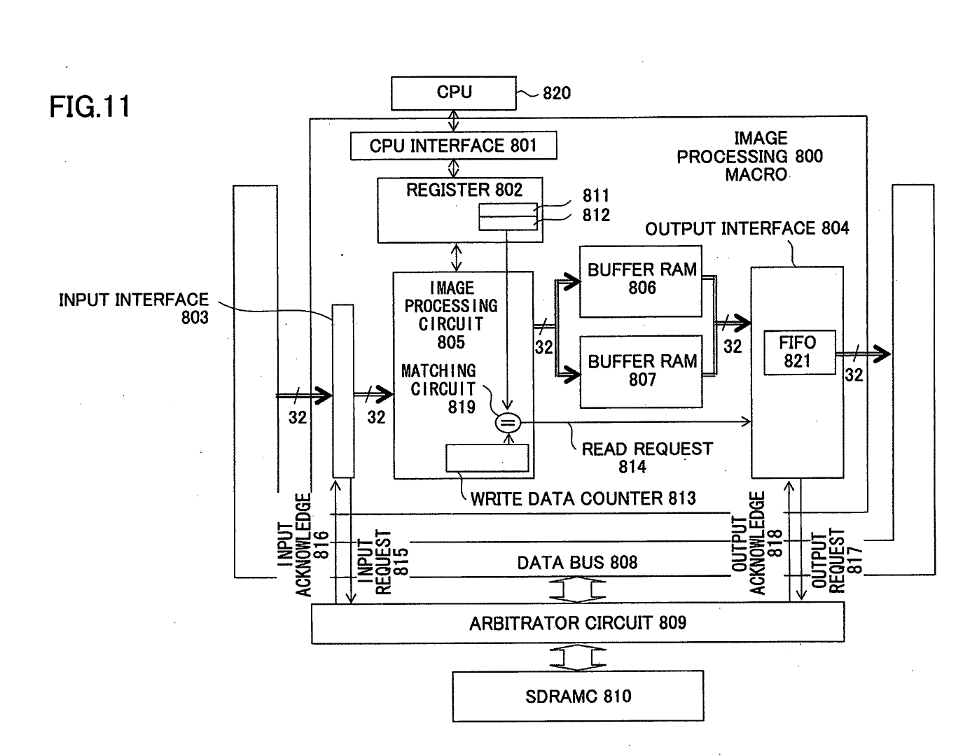

FIG. 11 is a block diagram showing an image processing macro according to yet another embodiment of the present invention. The image processing macro 800 shown in FIG. 11 is different from the image processing macro 600 shown in FIG. 9 in that one line of image data is transferred in four bursts. The configuration of the image processing macro 800 according to the present embodiment is different from that of the image processing macro shown in FIG. 9 in that a FIFO (first-in, first-out) 821 is provided in an output interface 819, and that what is sent from the matching circuit 819 to the output interface 804 is a read request signal 814. The FIFO 821 may be a 32-bit wide 2-port RAM with one read port and one write port (1R1W) for example.

In response to reception of the read request signal 814 from the matching circuit 819 of the image processing circuit 805, the output interface 804 sends a read signal to either the buffer RAM 806 or 807 depending on the state of the FIFO 821. That is, when the FIFO 821 is fully occupied, the output interface 804 negates the read signal, and when there is empty space for image data of at least one burst, the output interface 804 asserts the read signal.

On the other hand, when the FIFO 821 is filled with image data of at least one burst, the output interface 804 asserts the output request 817, and in response to reception of the output acknowledge 818, starts the burst transfer of image data stored in the FIFO 821. When the burst transfer has been completed, if image data of at least one burst has been stored in the FIFO 821, the output interface asserts the output request 817 in a continuous manner.

Remaining configuration of the image processing macro 800 shown in FIG. 11 is basically the same as the image processing macro 600 described with reference to FIG. 9.

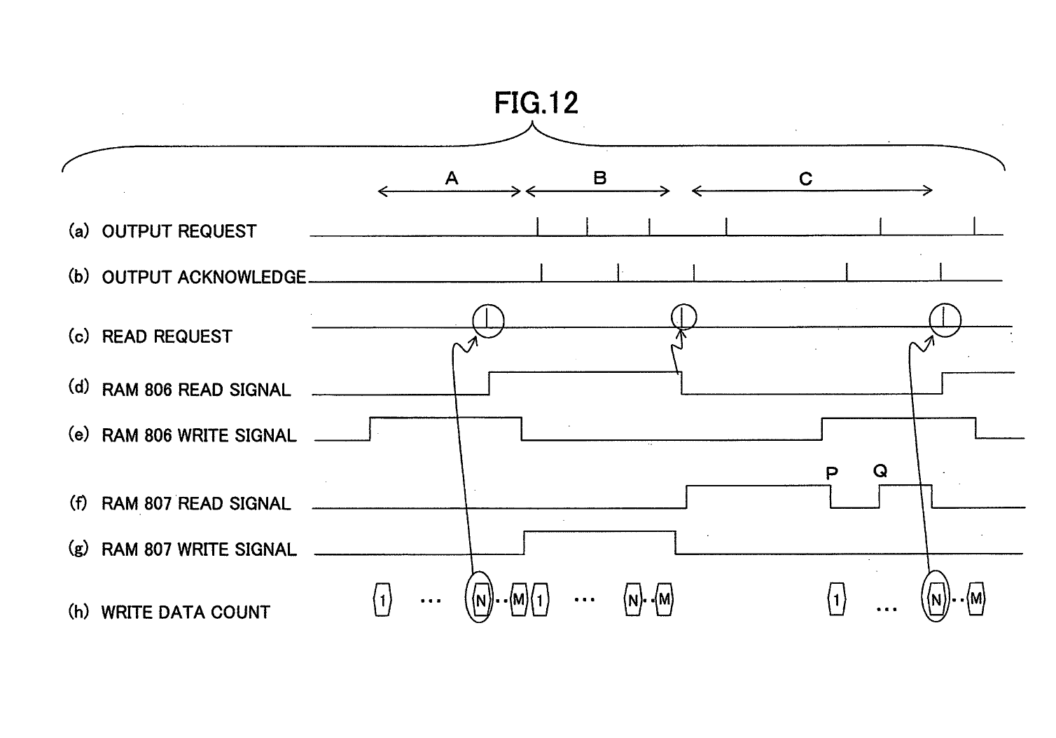

FIG. 12 is a waveform diagram showing the control signal waveforms of the buffer RAMs 806 and 807 according to the above embodiment.

In the time period C, the read signal (shown in FIG. 12(f)) for reading image data stored in the buffer RAM 807 is asserted, and the image data stored in the buffer RAM 807 is transferred to the FIFO 821. When the FIFO 821 is fully occupied, the read signal for reading image data stored in the buffer RAM 807 is negated (point in time P shown in FIG. 12(f)). When the burst transfer from the FIFO 821 has been completed, if there is an empty space (locations where no image data is written) for image data of one burst in the FIFO 821, the read signal for the buffer RAM 807 is asserted again (point in time Q shown in FIG. 12Q), resulting in the transfer from the buffer RAM 807 to the FIFO 821.

In the above embodiment, the value N which indicates the amount of image data that needs to be stored in the buffer RAM before the output request is allowed to be sent can be derived using the above expression (1).

It should be noted that, although the image processing macros 600 and 800 shown in FIGS. 9 and 11, respectively, have two buffer RAMs, three or more buffer RAMs can be provided. Those with ordinary skills in the art will easily recognize that the operation in such a case in which three or more buffer RAMs are provided is essentially the same as those of image processing macros 600 and 800.

Although the image processing macro 800 shown in FIG. 11 includes two buffer RAMs 806 and 807, only one buffer RAM may be provided instead.

The present invention is not limited to these embodiments, but various variations and modifications may be made without departing from the scope of the present invention.

This patent application is based on Japanese Priority Patent Application No. 2006-354262 filed on Dec. 28, 2006, the entire contents of which are hereby incorporated by reference.

What is claimed is:

1. A semiconductor apparatus,
comprising:
a data processing unit for processing data;
a buffer for temporarily storing the data processed by the data processing unit;
a buffer control unit for causing the data stored in the buffer to be burst-transferred to a data storage unit;
wherein the buffer control unit allows burst-transfer of the data stored in the buffer to be started before full amount of data to be transferred in a single burst-transfer is stored in the buffer.

2. The semiconductor apparatus as claimed in claim 1, wherein the buffer control unit allows the burst-transfer of the data stored in the buffer to be started so as to prevent any location in the buffer in which no data to be burst-transferred has been stored from being read.

3. The semiconductor apparatus as claimed in claim 1, wherein the buffer control unit allows the burst-transfer of the data stored in the buffer to be started based on a determination that amount of data stored in the buffer reaches a predetermined amount value.

4. The semiconductor apparatus as claimed in claim 3, wherein the predetermined amount value is determined to satisfy
N>(1−r0/r1)*M,
where M being the full amount of data to be transferred in a single burst-transfer, r0 being a rate at which data processed by the data processing unit is written to the buffer, r1 being a rate at which data stored in the buffer is burst-transferred to the data storage unit.

5. The semiconductor apparatus as claimed in claim 3, further comprising:
a counter for counting amount of data stored in the buffer;
a register for storing the predetermined amount value; and
a determination circuit for determining that the amount of data counted by the counter matches the predetermined amount value stored in the register.

6. The semiconductor apparatus as claimed in claim 3, further comprising a deriving unit for deriving the predetermined amount value.

7. The semiconductor apparatus as claimed in claim 5, further comprising an output interface for outputting data to a date transfer circuit, wherein the output interface sends an output request signal to the data transfer circuit in response to an output request permission signal from the determination circuit, and causes the buffer to output data in response to an output acknowledge from the data transfer circuit.

8. The semiconductor apparatus as claimed in claim 1, wherein
the buffer comprises at least a first sub-buffer and a second sub-buffer;
data processed by the data processing unit is alternately stored in the first sub-buffer and the second sub-buffer by the full amount of data to be transferred in a single burst-transfer; and
the buffer control unit allows burst-transfer of the data stored in one of the sub-buffers to be started before full amount of data to be transferred in a single burst-transfer is stored in the one of the sub-buffers so as to prevent any location in the one of the sub-buffers in which no data to be burst-transferred has been stored from being read, while burst-transfer of the other of the sub-buffers is not performed.

9. The semiconductor apparatus as claimed in claim 5, further comprising an output interface for outputting data to a data transfer circuit, the output interface comprising a FIFO, wherein the output interface causes the buffer to output data to the FIFO in response to a read request from the determination circuit.

10. The semiconductor apparatus as claimed in claim 1, wherein the buffer is a double port RAM with a write port and a read port.

11. The semiconductor apparatus as claimed in claim 1, wherein the data processing unit is an image processing unit for processing image data.

12. The semiconductor apparatus as claimed in claim 5, further comprising an input interface for receiving data to be supplied to the data processing unit.

13. The semiconductor apparatus as claimed in claim 7, wherein the data transfer circuit comprises an arbitration circuit for arbitrating accesses to a data but to prevent conflict.

14. The semiconductor apparatus as claimed in claim 5, further comprising another register for storing data for enabling the function of the buffer control unit that allows burst-transfer of the data stored in the buffer to be started before full amount of data to be transferred in a single burst-transfer is stored in the buffer.

15. A buffer control circuit for controlling a buffer that temporarily stores data processed by a data processing unit, comprising:
a counter for counting amount of data stored in the buffer;
a register for storing a predetermined amount value determined such that the buffer control circuit allows burst-transfer of data stored in the buffer to be started before full amount of data to be transferred in a single burst-transfer is stored in the buffer so as to prevent any location in the buffer in which no data to be burst-transferred has been stored from being read; and
a determination circuit for determining that the amount of data counted by the counter matches the predetermined amount value stored in the register.

16. A method of controlling burst-transfer, the method comprising:
storing in a buffer, data to be burst-transferred;
allowing the buffer to start burst-transfer of the data stored therein before full amount of data to be transferred in a single burst-transfer is stored in the buffer, so as to prevent any location in the buffer in which no data to be burst-transferred has been stored from being read.
